(19) United States
(12) Patent Application Publication
(10) Pub. No.: US 2025/0343012 A1
(43) Pub. Date: Nov. 6, 2025

(54) POWER STORAGE DEVICE

(71) Applicant: Panasonic Intellectual Property Management Co., Ltd., Osaka (JP)

(72) Inventors: Toshitaka KOBAYASHI, Osaka Fu (JP); Shunya IGARASHI, Osaka Fu (JP); Hiroki HAYASHI, Kyoto Fu (JP)

(73) Assignee: Panasonic Intellectual Property Management Co., Ltd., Osaka (JP)

(21) Appl. No.: 18/879,146

(22) PCT Filed: Jun. 26, 2023
(86) PCT No.: PCT/JP2023/023452

§ 371 Date: Dec. 26, 2024

(30) Foreign Application Priority Data
Jun. 29, 2022 (JP) 2022-104414

(51) Int. Cl. H01G 9/12; H01G 9/10

(52) U.S. Cl. CPC H01G 9/12; H01G 9/10

(57) ABSTRACT

A power storage device includes a power storage element, a bottomed cylindrical case having an opening portion, and a sealing unit sealing the opening portion. The sealing unit includes a sealing body having a first upper surface and a first lower surface, and a reinforcing member with an elastic modulus higher than that of the sealing body, having a second upper surface and a second lower surface facing the first upper surface. The case includes a first pressing portion pressing against the first side surface of the sealing body and protruding inward of the case, and a second pressing portion pressing against the second upper surface of the reinforcing member. The sealing unit has a first passage communicating with the outside of the power storage device further radially inward of the case than the second pressing portion and opening on the side surface of the sealing unit.

### TECHNICAL FIELD

The present disclosure relates to a power storage device.

### BACKGROUND ART

Conventionally, a power storage device has been known that includes a power storage element, a case having an opening portion at one end, and a sealing body that seals the opening portion (e.g., Patent Literature 1). The case of the power storage device of Patent Literature 1 includes, in the vicinity of the opening portion, a first pressing portion pressing against the side surface of the sealing body and protruding inward of the case, and a gas vent portion provided closer to the one end of the case than an apex that is the most protruding point of the first pressing portion. The power storage device of Patent Literature 1 is configured such that upon an increase in internal pressure due to generation of gas, the generated gas is released to the outside from the gas vent portion.

### CITATION LIST

### Patent Literature

Patent Literature 1: International Publication No. 2022/091862

### SUMMARY OF INVENTION

### Technical Problem

However, in the power storage device of Patent Literature 1, the sealing body is relatively largely deformed in the axial direction of the power storage device in a process from the increase in internal pressure to the release of the gas to the outside. In particular, when the power storage device is modularized for use, it is necessary to design the dimensions of the module so as to allow or absorb such deformation of the sealing body. In taking in account of the above, one object of the present disclosure is to suppress deformation of a sealing body when the internal pressure increases.

### Solution to Problem

One aspect of the present disclosure relates to a power storage device. The power storage device includes: a power storage element; a case with a bottomed cylindrical shape that houses the power storage element and that has an opening portion at one end; and a sealing unit that seals the opening portion, wherein the sealing unit includes: a sealing body having a first upper surface facing outward of the case and a first lower surface facing inward thereof, and a reinforcing member with an elastic modulus higher than that of the sealing body, the reinforcing member having a second upper surface facing outward of the case and a second lower surface facing inward thereof, the second lower surface facing the first upper surface, the case includes, in a vicinity of the opening portion; a first pressing portion pressing against a first side surface of the sealing body and protruding inward of the case, the first side surface connecting the first upper surface and the first lower surface of the sealing body; and a second pressing portion pressing against the second upper surface of the reinforcing member, and the sealing unit has a first passage that communicates with outside of the power storage device further radially inward of the case than the second pressing portion and that opens on a side surface of the sealing unit.

### Advantageous Effect of Invention

According to the present disclosure, deformation of the sealing body when the internal pressure increases can be suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic front cross-sectional view of a power storage device according to a first embodiment in a cross section taken along first passages (slits);

FIG. 2 is a schematic three-plane view of a reinforcing member in the first embodiment, which includes a plan view, a front view, and a bottom view in order from the top.

FIG. 3 is a schematic front cross-sectional view of a power storage device according to a second embodiment in a cross section taken along first passages (slits);

FIG. 4 is a schematic three-plane view of a reinforcing member in the second embodiment, which includes a plan view, a front view, and a bottom view in order from the top.

FIG. 5 is a schematic front cross-sectional view of a power storage device according to a third embodiment in a cross section taking along a first passage.

FIG. 6 is a schematic three-plane view of a reinforcing member in the third embodiment, which includes a plan view, a front view, and a bottom view in order from the top.

### DESCRIPTION OF EMBODIMENTS

Embodiments of a power storage device according to the present disclosure will be described below by way of example, but the present disclosure is not limited to the examples described below. In the following description, specific numerical values and materials may be exemplified in some cases, but other numerical values and other materials may be adopted as long as the effects of the present disclosure can be obtained.

The power storage device according to the present disclosure includes a power storage element, a case, and a sealing unit.

The power storage element includes an electrode and an electrolyte, for example. For example, when the power storage device is an electrolytic capacitor, the power storage element includes a wound body. The wound body is formed by winding a pair of electrodes with a separator therebetween. Each of the paired electrodes may be a polarizable electrode. Alternatively, one of the paired electrodes may be an anode and the other may be a cathode. For example, when the power storage device is a secondary battery or a lithium-ion capacitor, the power storage element includes an electrode group. The electrode group is formed by winding a positive electrode and a negative electrode with a separator therebetween. The power storage element may further include an electrolyte or a liquid component.

The case has a bottomed cylindrical shape having an opening portion at one end, and houses the power storage element. The case may be constituted of a metal containing, for example, aluminum, iron, or nickel. The shape of the case is not particularly limited, and may be a bottomed cylindrical shape, for example.

The sealing unit seals the opening portion of the case. The sealing unit includes a sealing body and a reinforcing member. The sealing body has a first upper surface facing outward of the case and a first lower surface facing inward of the case. The reinforcing member has a second upper surface facing outward of the case and a second lower surface facing inward of the case. The second lower surface faces the first upper surface of the sealing body. The first upper surface of the sealing body and the second lower surface of the reinforcing member may be in contact with each other, or a separate member may be provided therebetween.

The sealing body is constituted of an elastic material (e.g., a material containing an elastic resin). The shape of the sealing body may correspond to the shape of the case. For example, when the case has a bottomed cylindrical shape, the sealing body may have a disk shape. Alternatively, when the case has a bottomed rectangular cylindrical shape, the sealing body may have a rectangular plate shape. The reinforcing member is constituted of a material (e.g., a thermoplastic resin, a thermosetting resin, or a metal) having a higher elastic modulus than the material constituting the sealing body. Accordingly, the elastic modulus of the reinforcing member is higher than the elastic modulus of the sealing body. The elastic modulus may be Young's modulus, for example. The shape of the reinforcing member may correspond to the shape of the case.

As the elastic resin constituting the sealing body, a rubber component is desirable. Examples of the rubber component include butyl rubber (IIR), nitrile rubber (NBR), ethylene propylene rubber, ethylene propylene diene rubber (EPDM), chloroprene rubber (CR), isoprene rubber (IR), hyperon rubber, silicone rubber, and fluororubber, any of which can be used solely or blended. Among them, butyl rubber, ethylene propylene rubber, and fluorine rubber are preferable, for example. In addition to the elastic resin, the elastic material may contain, as optional components, a filler, carbon black, a processing aid, and a cross-linking agent, for example. The elastic resin may have an elastic modulus E1 of 15 MPa or less, for example.

As a material constituting the reinforcing member, a thermoplastic resin is desirable. Examples of the thermoplastic resin include polypropylene (PP), polyethylene (PE), ABS resin (ABS), polystyrene (PS), polyvinyl chloride resin (PVC), and polyethylene terephthalate (PET), any of which can be used solely or blended. Among them, polypropylene is desirable. The reinforcing member may have an elastic modulus E2 of 1.1 GPa or more, for example.

The case has a first pressing portion and a second pressing portion in the vicinity of the opening portion.

The first pressing portion presses against a first side surface of the sealing body (i.e., the side surface of the sealing body that connects the first upper surface and the first lower surface), and protrudes inward of the case. The inner diameter at an apex that is the most protruding point of the first pressing portion may be smaller than the outer diameter of the sealing body in an unloaded state. The first pressing portion may be formed, for example, by grooving for reducing the diameter of a part of the opening portion.

The second pressing portion is provided closer to one end, that is, the opening, of the case than the first pressing portion, and presses against the second upper surface of the reinforcing member inward of the case. The second pressing portion may be formed, for example, by curling a part of the tip end of the opening.

The sealing unit has a first passage that can function as an explosion-proof mechanism. The first passage communicates with the outside of the power storage device radially inward of the case relative to the second pressing portion. The first passage opens on the side surface of the sealing unit (i.e., the side surface of either the sealing body or the reinforcing member or both). Here, the first passage may open only at a site of the side surface of the sealing unit, located closer to the second upper surface (close to the opening) than the apex that is the most protruding point of the first pressing portion. The first passage does not open to the lower surface (the surface facing inward of the case) of the sealing unit. The first passage may allow communication between the inside and the outside of the case when the force acting on the first pressing portion from the sealing body falls below a predetermined value due to an increase in internal pressure of the case.

Here, when the internal pressure of the case increases due to generation of gas, the sealing body tends to expand outward of the case in the axial direction of the case. However, in the power storage device of the present disclosure, the expansion (or deformation of the sealing body) in the axial direction is suppressed by the reinforcing member having a high elastic modulus (i.e., hardly deformable characteristic). As the internal pressure of the case increases in a state in which expansion of the sealing body is suppressed, the pressure of the gas acts on an area of the sealing body in contact with the first pressing portion to displace the area in a direction away from the first pressing portion. The displacement reduces a force acting on the first pressing portion from the sealing body (elastic repulsive force against compression). When the acting force reduces to below a predetermined value, the gas in the case passes between the sealing body and the first pressing portion. Escape of the gas from the inside of the case to the outside of the case via the first passage reduces the internal pressure of the power storage device to ensure safety.

As described above, according to the present disclosure, providing the reinforcing member having a high elastic modulus can suppress deformation of the sealing body when the internal pressure of the case increases. According to the present disclosure, with the operation of the explosion-proof mechanism, it is possible to prevent an unexpected rupture of the power storage device which may cause scattering of the sealing unit.

The first passage may be formed only in the reinforcing member of the sealing unit. In the above configuration, since the first passage is not formed in the sealing body having a relatively low elastic modulus, the sealing body is less likely to be deformed when the internal pressure increases compared to a configuration in which the first passage is formed also in the sealing body. The first passage may be formed in the sealing unit, for example, to bridge over the reinforcing member and the sealing body.

The first passage may have a slit opening on the second upper surface of the reinforcing member. The slit may extend further radially inward of the case than the second pressing portion. The slit may open on the side surface of the reinforcing member.

The slit may pass through the reinforcing member in the thickness direction thereof. In the above configuration, the slit may be formed only in the reinforcing member or may be formed to bridge over the reinforcing member and the sealing body.

The slit may not pass through the reinforcing member in the thickness direction thereof. In the above configuration, the slit may be formed only in the reinforcing member.

The outer periphery of the second lower surface of the reinforcing member may be in contact with the first upper surface of the sealing body along the entire circumference. In the above configuration, deformation of the sealing body at an increase in internal pressure can be even further suppressed. Even a configuration in which the outer peripheral edge of the second lower surface juts outward to some extent from the outer peripheral edge of the first upper surface of the sealing body shall correspond to the configuration described in this paragraph as long as the outer periphery of the second lower surface of the reinforcing member is in contact, inside the jut, with the first upper surface of the sealing body along the entire circumference.

The first passage has a first opening that opens on the second upper surface of the reinforcing member and that communicates with the outside of the power storage device, and a second opening that opens on the side surface of the sealing unit. The first passage may pass through the inside of the sealing unit. The second opening may open on the side surface of the reinforcing member, may open on the side surface of the sealing body, or may be open to bridge over both side surfaces.

The second pressing portion may press against the second upper surface of the reinforcing member along the entire circumference. In the above configuration, deformation of the sealing body when the internal pressure increases can be even further suppressed. Further, the entire circumference of the second pressing portion contacts with the second upper surface of the reinforcing member. Therefore, in forming the second pressing portion, the second pressing portion can be formed easily with high accuracy.

The first passages may be provided as a plurality of first passages. In a configuration in which a plurality of first passages are provided, the plurality of first passages may be arranged at equal intervals in the circumferential direction of the case. This can prevent asymmetrical deformation of the sealing body to increase operational reliability of the explosion-proof mechanism of the first passages.

Hereinafter, examples of the power storage device according to the present disclosure will be specifically described with reference to the drawings. The elements of configuration described above are applicable to elements of configuration of example power storage devices described below. The elements of configuration of the example power storage devices described below can be altered based on the above description. Further, the matters described below may be applied to the above-described embodiment. Among the elements of configuration of the example power storage devices described below, an element of configuration that is not essential to the power storage device according to the present disclosure may be omitted. It should be noted that the drawings indicated below are schematic and do not accurately reflect the shape or number of actual members.

### First Embodiment

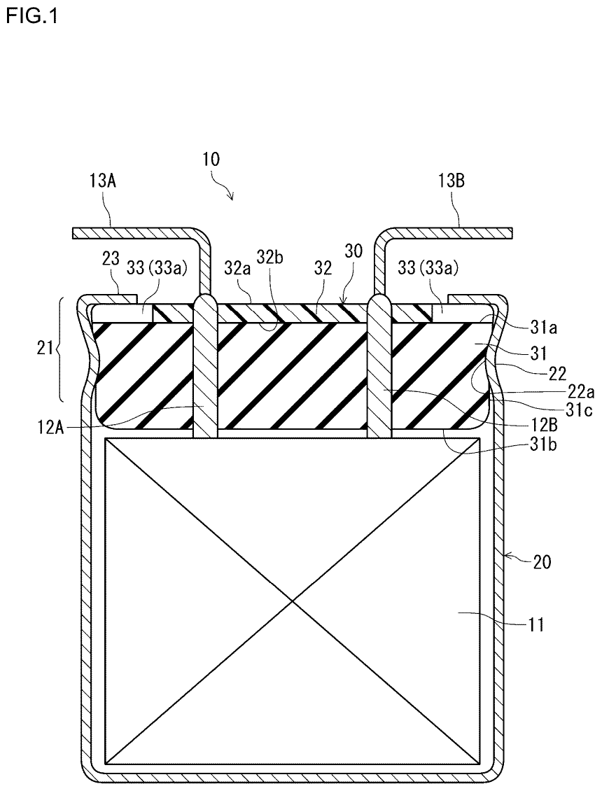

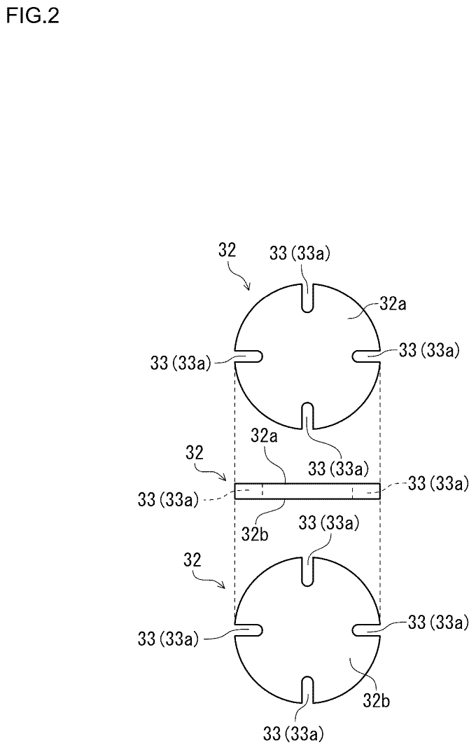

The following describes a first embodiment of the present disclosure. As illustrated in FIGS. 1 and 2, a power storage device 10 of the present embodiment is configured as an electrolytic capacitor, and includes a power storage element 11, a case 20, and a sealing unit 30.

The power storage element 11 includes a wound body. The wound body is formed by winding an anode foil and a cathode foil with a separator therebetween. One end of a lead tab 12A is connected to the anode foil, while one end of a lead tab 12B is connected to the cathode foil. The wound body is configured to be wound together with the lead tabs 12A and 12B. The other end of the lead tab 12A is connected to a lead wire 13A, while the other end of the lead tab 12B is connected to a lead wire 13B.

The case 20 has a bottomed cylindrical shape having an opening portion 21 at one end, and houses the power storage element 11. The case 20 of the present embodiment is constituted of aluminum, but is not limited thereto. The case 20 of the present embodiment has a bottomed cylindrical shape, but is not limited thereto. The axial length of the case 20 may be, for example, 60 to 80 mm prior to formation of a first pressing portion 22 and a second pressing portion 23, which will be described later. The outer diameter of the case 20 may be 16 to 20 mm, for example.

The sealing unit 30 seals the opening portion 21 of the case 20. The thickness of the sealing unit 30 (the length in the axial direction of the case 20) may be 3 to 7 mm, for example. The sealing unit 30 includes a sealing body 31 and a reinforcing member 32. The sealing body 31 has a first upper surface 31a facing outward of the case 20 and a first lower surface 31b facing inward of the case 20. The reinforcing member 32 has a second upper surface 32a facing outward of the case 20 and a second lower surface 32b facing inward of the case 20. The second lower surface 32b faces the first upper surface 31a of the sealing body 31. In the present embodiment, the first upper surface 31a of the sealing body 31 and the second lower surface 32b of the reinforcing member 32 are in contact with each other.

The sealing body 31 is constituted of an elastic body containing rubber as a main component. The sealing body 31 in the present embodiment has a disk shape, but is not limited thereto. The thickness of the sealing body 31 may be 3.0 to 6.0 mm, for example. The reinforcing member 32 is constituted of a thermoplastic resin (e.g., polypropylene). That is, the reinforcing member 32 is constituted of a material having a higher elastic modulus than the constituent material of the sealing body 31. The reinforcing member 32 in the present embodiment has a disk shape having a diameter equal to that of the sealing body 31, but is not limited thereto. The thickness of the reinforcing member 32 may be 1.0 to 3.0 mm, for example, The case 20 has a first pressing portion 22 and a second pressing portion 23 in the vicinity of the opening portion 21.

In the vicinity of the opening portion 21, the first pressing portion 22 presses against a first side surface 31c of the sealing body 31 and protrudes inward of the case 20. The inner diameter of the first pressing portion 22 at an apex 22a is smaller than the outer diameter of the sealing body 31 in an unloaded state. The first pressing portion 22 in the present embodiment is, but is not limited to being, formed by grooving for reducing the diameter of a part of the opening portion 21.

The second pressing portion 23 is provided closer to one end (i.e., the opening) of the case 20 than the first pressing portion 22, and presses against the second upper surface 32a of the reinforcing member 32 inward of the case 20. In other words, the second pressing portion 23 presses the edge of the sealing unit 30 in the vicinity of the opening portion 21. The second pressing portion 23 in the present embodiment is, but is not limited to being, formed by curling a part of the opening portion 21.

The sealing unit 30 has first passages 33 that can function as an explosion-proof mechanism. Each of the first passages 33 is formed only in the reinforcing member 32 of the sealing unit 30. The first passage 33 communicates with the outside of the power storage device 10 further radially inward of the case 20 than the second pressing portion 23. The first passage 33 opens only at a site of the side surface of the sealing unit 30 that is located closer to the second upper surface 32a (opening portion) than to the apex 22a that is the most protruding point of the first pressing portion 22. The apex 22a of the first pressing portion 22 is an essential part for securing airtightness of the case 20. It is advantageous from the viewpoint of securing airtightness that the first passage 33 does not open there.

The first passage 33 is constituted of a slit 33a that opens on the second upper surface 32a of the reinforcing member 32. The slit 33a in the present embodiment passes through the reinforcing member 32 in the thickness direction thereof. For example, the slit 33a may extend radially inward by only 0.2 to 2.0 mm from the radially inner end of the second pressing portion 23. The width of the slit 33a (the length in the circumferential direction of the case 20) may be 0.2 to 0.5 mm, for example. The slit 33a extends in the radial direction of the case 20, but is not limited thereto.

As illustrated in FIG. 2, four first passages 33 each constituted of a slit 33a are provided in the present embodiment. However, the number of the first passages 33 may be 3 or less or 5 or more. The four first passages 33 are arranged at equal intervals (every 90° in this example) in the circumferential direction of the case 20. However, the plurality of first passages 33 may not be arranged at equal intervals. In FIG. 2, the through-holes for allowing the lead tabs 12A and 12B to pass therethrough are omitted.

A part of the opening portion 21 that is closer to the opening than the apex 22a of the first pressing portion 22 may not be in partial contact with the sealing unit 30. That is, a gap may be present between the inner surface of the opening portion 21 and the side surface of the sealing unit 30 at a site located closer to the opening than the apex 22a of the first pressing portion 22. When the gap is present, the first passages 33 may be in communication with the gap.

Here, when the internal pressure of the case 20 increases due to generation of gas, the sealing body 31 tends to expand outward of the case 20 in the axial direction of the case 20. However, in the power storage device 10 of the present disclosure, the expansion (or deformation of the sealing body 31) in the axial direction is suppressed by the reinforcing member 32 having a high elastic modulus (i.e., hardly deformable characteristic). As the internal pressure of the case 20 increases in a state in which the expansion of the sealing body 31 is suppressed, the pressure of the gas acts on an area of the sealing body 31 in contact with the first pressing portion 22 to displace the area in a direction away from the first pressing portion 22. The displacement reduces a force acting on the first pressing portion 22 from the sealing body 31 (elastic repulsive force against compression). When the acting force reduces to below a predetermined value, the gas in the case 20 passes between the sealing body 31 and the first pressing portion 22. Escape of the gas from the inside of the case 20 to the outside of the case 20 via the first passages 33 reduces the internal pressure of the power storage device 10 to ensure safety.

### Second Embodiment

The following describes a second embodiment of the present disclosure. The configuration of a sealing unit 30 of a power storage device 10 of the present embodiment is different from that of the first embodiment. Hereinafter, differences from the first embodiment will be mainly described.

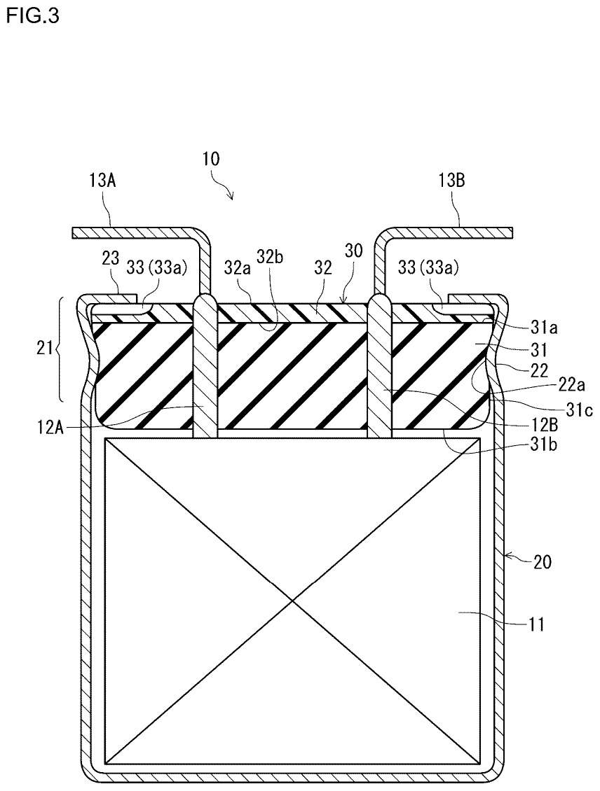

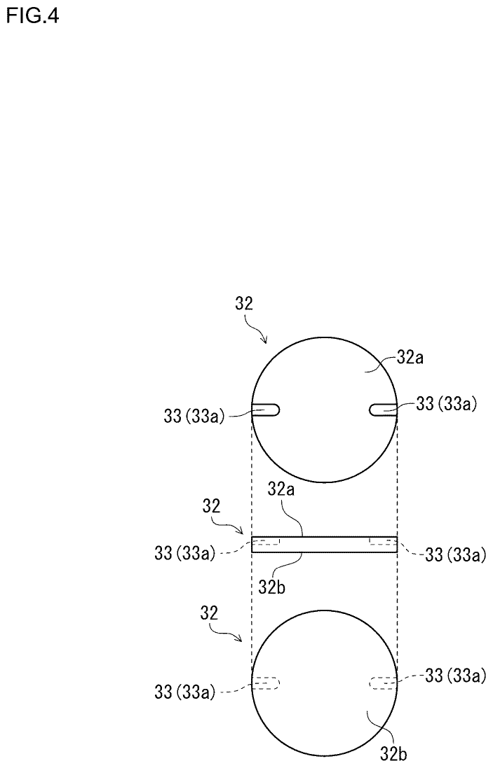

As illustrated in FIGS. 3 and 4, first passages 33 configured as slits 33a do not pass through a reinforcing member 32 in the thickness direction thereof. The outer periphery of the second lower surface 32b of the reinforcing member 32 is in contact with a first upper surface 31a of a sealing body 31 along the entire circumference. Two first passages 33 are provided at equal intervals (in this example, at intervals of 180°) in the circumferential direction of a case 20.

### Third Embodiment

The following descries a third embodiment of the present disclosure. The configuration of a sealing unit 30 of a power storage device 10 of the present embodiment is different from that of the first embodiment. Hereinafter, differences from the first embodiment will be mainly described.

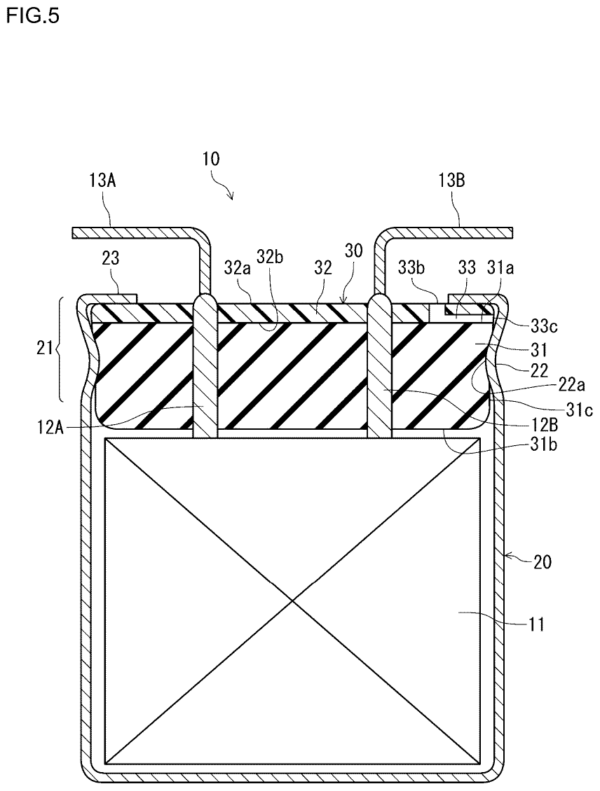

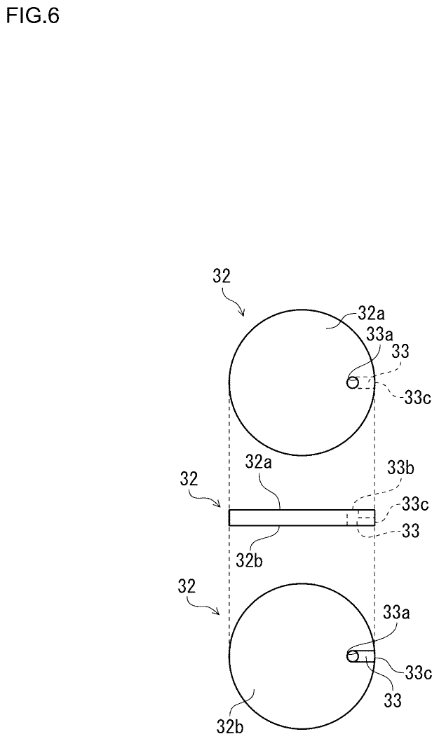

As illustrated in FIGS. 5 and 6, a first passage 33 in the present embodiment passes inside the sealing unit 30, and has a first opening 33b and a second opening 33c. The first opening 33b opens on a second upper surface 32a of a reinforcing member 32 and communicates with the outside of the power storage device 10. The second opening 33c opens on the side surface of a sealing unit 30 (in this example, the side surface of the reinforcing member 32). The second pressing portion 23 presses against the second upper surface 32a of the reinforcing member 32 along the entire circumference. In the present embodiment, only one first passage 33 is provided.

Although the present invention has been described in terms of the presently preferred embodiments, it is to be understood that such disclosure is not to be interpreted as limiting. For example, matters recited in any two or more claims selected from multiple claims in the appended claims can be combined as long as no technical contradiction arises.

### Additional Remarks

According to the above description of the embodiments, the following techniques are disclosed.

### Technique 1

A power storage device including:
a power storage element;
a case with a bottomed cylindrical shape that houses the power storage element and that has an opening portion at one end; and
a sealing unit that seals the opening portion, wherein
the sealing unit includes:
   a sealing body having a first upper surface facing outward of the case and a first lower surface facing inward thereof; and
   a reinforcing member with an elastic modulus higher than that of the sealing body, the reinforcing member having a second upper surface facing outward of the case and a second lower surface facing inward thereof, the second lower surface facing the first upper surface,
the case includes, in a vicinity of the opening portion;
   a first pressing portion pressing against a first side surface of the sealing body and protruding inward of the case, the first side surface connecting the first upper surface and the first lower surface of the sealing body; and
   a second pressing portion pressing against the second upper surface of the reinforcing member, and
the sealing unit has a first passage that communicates with outside of the power storage device further radially inward of the case than the second pressing portion and that opens on a side surface of the sealing unit.

### Technique 2

The power storage device according to Technique 1, wherein the first passage is formed only in the reinforcing member of the sealing unit.

### Technique 3

The power storage device according to Technique 1 or 2, wherein the first passage has a slit that opens on the second upper surface of the reinforcing member.

### Technique 4

The power storage device according to Technique 3, wherein the slit passes through the reinforcing member in a thickness direction of the reinforcing member.

### Technique 5

The power storage device according to Technique 3, wherein the slit does not pass through the reinforcing member in a thickness direction of the reinforcing member.

### Technique 6

The power storage device according to Technique 5, wherein an outer periphery of the second lower surface of the reinforcing member is in contact with the first upper surface of the sealing body along an entire circumference.

### Technique 7

The power storage device according to Technique 1 or 2, wherein the first passage has a first opening that opens on the second upper surface of the reinforcing member and that communicates with the outside of the power storage device, and a second opening that opens on the side surface of the sealing unit, and the first passaging passes inside the sealing unit.

### Technique 8

The power storage device according to Technique 7, wherein the second pressing portion presses against the second upper surface of the reinforcing member along an entire circumference.

### Technique 9

The power storage device according to any of Techniques 1 to 8, wherein the first passage opens at a site of the side surface of the sealing unit that is closer to the second upper surface of the reinforcing member than an apex that is a most protruding point of the first pressing portion.

### Technique 10

The power storage device according to Techniques 1 to 8, wherein the first passage is provided as a plurality of first passages.

### Technique 11

The power storage device according to Technique 10, wherein the plurality of first passages are arranged at equal intervals in a circumferential direction of the case.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### INDUSTRIAL APPLICABILITY

The present disclosure can be used for power storage devices.

### REFERENCE SIGNS LIST

10: Power storage device
11: Power storage element
12A, 12B: Lead Tab
13A, 13B: Lead wire
20: Case
21: Opening portion
22: First pressing portion
22a: Apex
23: Second pressing portion
30: Sealing unit
31: Sealing body
31a: First upper surface
31b: First lower surface
31c: First side surface
32: Reinforcing member
32a: Second upper surface
32b: Second lower surface
33: First passage
33a: Slit
33b: First opening
33c: Second opening

1. A power storage device comprising:
a power storage element;
a case with a bottomed cylindrical shape that houses the power storage element and that has an opening portion at one end; and
a sealing unit that seals the opening portion, wherein
the sealing unit includes:
a sealing body having a first upper surface facing outward of the case and a first lower surface facing inward thereof; and
a reinforcing member with an elastic modulus higher than that of the sealing body, the reinforcing member having a second upper surface facing outward of the case and a second lower surface facing inward thereof, the second lower surface facing the first upper surface,
the case includes, in a vicinity of the opening portion;
a first pressing portion pressing against a first side surface of the sealing body and protruding inward of the case, the first side surface connecting the first upper surface and the first lower surface of the sealing body; and
a second pressing portion pressing against the second upper surface of the reinforcing member, and
the sealing unit has a first passage that communicates with outside of the power storage device further radially inward of the case than the second pressing portion and that opens on a side surface of the sealing unit.

2. The power storage device according to claim 1, wherein
the first passage is formed only in the reinforcing member of the sealing unit.

3. The power storage device according to claim 1, wherein
the first passage has a slit that opens on the second upper surface of the reinforcing member.

4. The power storage device according to claim 3, wherein
the slit passes through the reinforcing member in a thickness direction of the reinforcing member.

5. The power storage device according to claim 3, wherein
the slit does not pass through the reinforcing member in a thickness direction of the reinforcing member.

6. The power storage device according to claim 5, wherein
an outer periphery of the second lower surface of the reinforcing member is in contact with the first upper surface of the sealing body along an entire circumference.

7. The power storage device according to claim 1, wherein
the first passage has a first opening that opens on the second upper surface of the reinforcing member and that communicates with the outside of the power storage device, and a second opening that opens on the side surface of the sealing unit, and
the first passaging passes inside the sealing unit.

8. The power storage device according to claim 7, wherein
the second pressing portion presses against the second upper surface of the reinforcing member along an entire circumference.

9. The power storage device according to claim 1, wherein
the first passage opens at a site of the side surface of the sealing unit that is closer to the second upper surface of the reinforcing member than an apex that is a most protruding point of the first pressing portion.

10. The power storage device according to claim 1, wherein
the first passage is provided as a plurality of first passages.

11. The power storage device according to claim 10, wherein
the plurality of first passages are arranged at equal intervals in a circumferential direction of the case.
